(19) United States
(12) Patent Application Publication
(10) Pub. No.: US 2008/0036441 A1
(43) Pub. Date: Feb. 14, 2008

(54) Voltage regulating circuit having voltage stabilizing circuits

(75) Inventor: Huai Du, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOCOM TECHNOLOGY (SHENZHEN) CO., LTD. INNOLUX DISPLAY CORP.

(21) Appl. No.: 11/891,798

(22) Filed: Aug. 13, 2007

(30) Foreign Application Priority Data
Aug. 11, 2006 (TW) 95129529

(51) Int. Cl. G05F 3/08

(52) U.S. Cl. 323/311

(57) ABSTRACT

An exemplary voltage regulating circuit (20) includes a voltage modulating unit (22, 24) and a voltage-dividing unit (26). The voltage-dividing unit includes a voltage divider (27) and at least one voltage stabilizing circuit (28) electrically coupled to the voltage divider. The voltage modulating unit transforms an input voltage to an operation voltage. The voltage divider divides the operation voltage into a plurality of sub-voltages, the at least one voltage stabilizing circuit stabilizes a corresponding one of the sub-voltages at a desired value, and the at least one voltage stabilizing circuit outputs the stabilized voltage.

### FIELD OF THE INVENTION

The present invention relates to voltage regulating circuits, and more particularly to a voltage regulating circuit having voltage stabilizing circuits, the voltage regulating circuit typically being used in a liquid crystal display (LCD).

### GENERAL BACKGROUND

Voltage regulating circuits are widely used in various electronic products, including liquid crystal displays (LCDs).

FIG. 5 is a diagram of a conventional voltage regulating circuit used in an LCD. The voltage regulating circuit 10 is typically installed in a driver integrated circuit, and provides a plurality of output voltages for driving the LCD. The voltage regulating circuit 10 includes a voltage-increasing unit 12, a voltage-reducing unit 14, and a voltage-dividing unit 16. The voltage-increasing unit 12, the voltage-reducing unit 14, and the voltage-dividing unit 16 are electrically coupled in series. The voltage-dividing unit 16 includes a resistor-string (not labeled), which includes a plurality of voltage-dividing resistors electrically coupled in series. One terminal of the resistor-string is electrically coupled to the voltage-reducing unit 14, and the other terminal of the resistor-string is grounded. Moreover, nodes between each two adjacent voltage-dividing resistors, as well as both terminals of the resistor-string, act as output terminals of the voltage-dividing unit 16.

In operation, the voltage-increasing circuit 12 transforms an input voltage to a high voltage, and outputs the high voltage to the voltage-reducing unit 14. The voltage-reducing unit 14 transforms the high voltage to an operation voltage, and outputs the operation voltage to the voltage-dividing unit 16. The voltage-dividing unit 16 divides the operation voltage into a plurality of output voltages via the voltage-dividing resistors of the resistor-string, and outputs the output voltages via the corresponding output terminals.

Desired output voltages can be obtained by modulating the pulse width or the operation frequency of either the voltage-increasing unit 12 or the voltage-reducing unit 14, as well as by regulating a resistance of any of the voltage-dividing resistors. For example, in the illustrated embodiment, one of the voltage-dividing resistors is a variable resister.

However, defects and variations inevitably occur during the process of manufacturing the voltage regulating circuit 10, particularly when the voltage regulating circuit 10 is installed in an integrated circuit. These defects and variations cause the actual values of output voltages of the voltage regulating circuit 10 to deviate from the theoretical values. That is, the accuracy of the output voltages and the reliability of the voltage regulating circuit 10 may not be satisfactory. When the voltage regulating circuit 10 is applied in the LCD for providing driving voltages thereto, the deviations in the output voltages are liable to reduce the display quality of the LCD, and to cause the phenomenon of crosstalk in the LCD.

It is desired to provide a voltage regulating circuit used in an LCD which overcomes the above-described deficiencies.

### SUMMARY

In one aspect, a voltage regulating circuit includes a voltage modulating unit and a voltage-dividing unit. The voltage-dividing unit includes a voltage divider and at least one voltage stabilizing circuit electrically coupled to the voltage divider. The voltage modulating unit transforms an input voltage to an operation voltage. The voltage divider divides the operation voltage into a plurality of sub-voltages, the at least one voltage stabilizing circuit stabilizes a corresponding one of the sub-voltages at a desired value, and the at least one voltage stabilizing circuit outputs the stabilized voltage.

In another aspect, a voltage regulating circuit includes a voltage modulating unit and a voltage-dividing unit. The voltage-dividing unit includes a voltage divider and a plurality of voltage stabilizing circuits electrically coupled to the voltage divider. The voltage modulating unit transforms an input voltage to an operation voltage. The voltage divider divides the operation voltage into a plurality of sub-voltages, and each of the voltage stabilizing circuits stabilizes a respective one of the sub-voltages at a desired value and outputs the stabilized sub-voltage to a load.

Other novel features and advantages will become more apparent from the following detailed description when taken in conjunction with the accompanying drawings.

### BRIEF DESCRIPTION OF THE DRAWINGS

FIG. 1 is a diagram of a voltage regulating circuit according to a first exemplary embodiment of the present invention.

FIG. 2 is a diagram of one of plural voltage stabilizing circuits of the voltage regulating circuit of FIG. 1.

FIG. 3 is a diagram of a voltage stabilizing circuit of a voltage regulating circuit according to a second exemplary embodiment of the present invention.

FIG. 4 is a diagram of a voltage stabilizing circuit of a voltage regulating circuit according to a third exemplary embodiment of the present invention.

FIG. 5 is a diagram of a conventional voltage regulating circuit.

### DETAILED DESCRIPTION OF PREFERRED EMBODIMENTS

Reference will now be made to the drawings to describe preferred and exemplary embodiments of the present invention in detail.

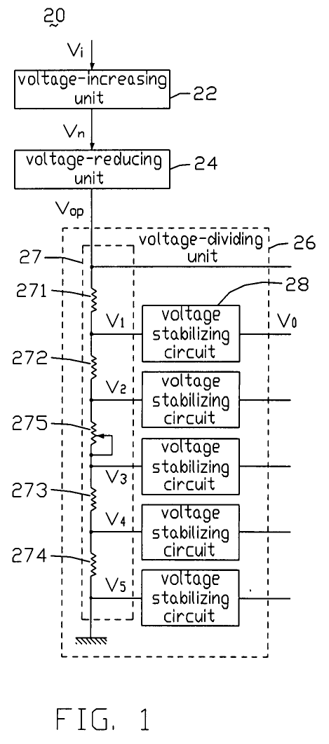

FIG. 1 is a diagram of a voltage regulating circuit according to a first exemplary embodiment of the present invention. The voltage regulating circuit 20 is typically installed in a driver integrated circuit, and provides a plurality of output voltages to drive an LCD. The voltage regulating circuit 20 includes a voltage-increasing unit 22, a voltage-reducing unit 24, and a voltage-dividing unit 26. The voltage-increasing 22, the voltage-reducing unit 24, and the voltage-dividing unit 26 are electrically coupled in series.

The voltage-dividing unit 26 includes a voltage divider 27, and a plurality of voltage stabilizing circuits 28 electrically coupled to the voltage divider 27. The voltage divider 27 can be a resistor voltage divider, which includes a plurality of resistors electrically connected in series and grounded at one end. A resistance of each resistor can be fixed or variable. In the illustrated embodiment, the voltage divider 27 includes a first resistor 271, a second resistor 272, a third resistor 273, a fourth resistor 274, a variable resistor 275; and there are five voltage stabilizing circuits 28.

One terminal of the first resistor 271 is electrically coupled to the voltage-reducing unit 24, and the other terminal of the first resistor 271 is grounded via a resistor-string. The resistor-string includes the second resistor 272, the variable resistor 275, the third resistor 273, and the fourth resistor 274 electrically coupled in series. Each node between two adjacent coupled resistors is electrically coupled to a respective voltage stabilizing circuit 28. For example, the node between the first resistor 271 and the second resistor 272 is electrically coupled to a first one of the voltage stabilizing circuits 28. Further, the node between the fourth resistor 274 and ground is electrically coupled to the fifth (i.e., the last) voltage stabilizing circuit 28. Moreover, the resistance of the first resistor 271 is equal to the resistance of each of the second, third, and fourth resistors 272, 273, 274.

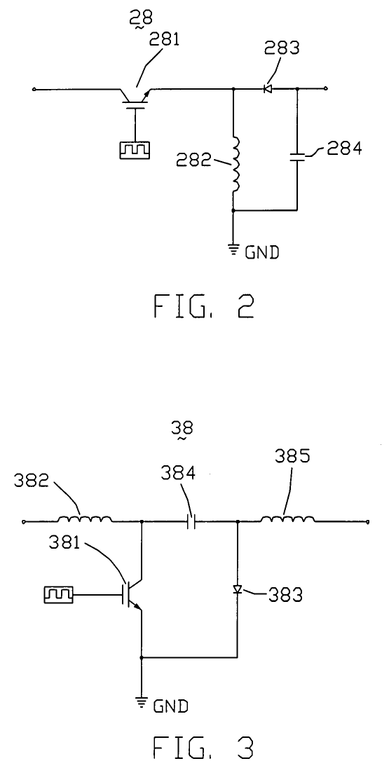

FIG. 2 is a diagram of any one of the voltage stabilizing circuits 28 of the voltage regulating circuit 20. The voltage stabilizing circuit 28 can be a boost-buck circuit, which includes a transistor 281, an inductor 282, a diode 283, and a capacitor 284. The transistor 281 acts as a switch element, and can for example be an insulated gate bipolar transistor (IGBT). A base electrode of the transistor 281 serves as a control terminal to receive a control signal V_{c} of the voltage stabilizing circuit 28. The control signal V_{c} is produced by the driver integrated circuit in which the voltage regulating circuit 20 is installed. A collector electrode of the transistor 281 serves as an input of the voltage stabilizing circuit 28, and is electrically coupled to the voltage divider 27 to receive a divided voltage signal outputted by the voltage divider 27. An emitter electrode of the transistor 281 is grounded via the inductor 282, and is electrically coupled to a negative terminal of the diode 283. A positive terminal of the diode 283 serves as an output of the voltage stabilizing circuit 28, and is grounded via the capacitor 284.

Operation of the voltage regulating circuit 20 is as follows. The voltage-increasing unit 22 receives an input voltage Vᵢ, and transforms the input voltage Vᵢ to a higher voltage Vₙ. The higher voltage Vₙ is then received by the voltage-reducing unit 24, and transformed to an operation voltage Vₒₚ by the voltage-reducing unit 24. The voltage-dividing unit 26 receives the operation voltage Vₒₚ, and divides the operation voltage Vₒₚ into a plurality of sub-voltages via the voltage divider 27. In detail, when the operation voltage Vₒₚ is received by the voltage divider 27, a current is produced. When the current passes through the five resistors 271, 272, 273, 274, 275 which are electrically coupled in series, each resistor 271, 272, 273, 274, 275 generates a bias voltage. Due to the bias voltages, the operation voltage Vₒₚ is divided into five sub-voltages V₁, V₂, V₃, V₄, V₅, as illustrated in FIG. 1. Supposing the resistances of the resistors 271, 272, 273, 274 are R, and the resistance of the variable resistor 275 is nR, where the coefficient n can be changed to a desired value, the five sub-voltages V₁, V₂, V₃, V₄, V₅ can be obtained by the following formulae:

V₁=(1/K)*Vₒₚ;

V₂=(2/K)*Vₒₚ;

V₃=(1−1/K)*Vₒₚ;

V₄=(1−1/K)*Vₒₚ; and

V₅=0V;

The coefficient K can be calculated according to the formula:

K=(R+R+nR+R+R)/R=4+n.

Each voltage stabilizing circuit 28 receives a corresponding sub-voltage V₁, V₂, V₃, V₄, V₅ from the voltage divider 27 via the collector electrode of the transistor 281, and simultaneously receives the control signal V_{c} via the base electrode of the transistor 281. The control signal VC is a periodical impulse. When the control signal V_{c} is a high voltage signal, the transistor 281 turns to an on-state. The inductor 282 generates an inductive current, transforms the electrical energy to magnetic energy, and then stores the magnetic energy. Moreover, the inductive current charges the capacitor 284. Due to the voltage of the capacitor 284, the diode 283 changes to a reverse bias, and turns to an off-state. After the capacitor 284 becomes fully charged, the voltage of the capacitor 284 maintains a fixed value. Then the voltage of the capacitor 284 is provided as an output signal Vₒ of the voltage stabilizing circuit 28, and the output signal Vₒ is output to a load (not shown).

When the control signal V_{c} is a low voltage signal, the transistor 281 turns to an off-state. The inductor 282 produces an inductive potential, which causes the diode 284 to change to a forward bias, and turn to an on-state. The magnetic energy storing in the inductor 282 is then transformed to electrical energy, and is provided to the capacitor 284 to prevent the voltage of the capacitor 284 from diminishing. The voltage of the capacitor 284 continues to serve as the output signal Vₒ of the voltage stabilizing circuit 28, and is output to the load (not shown).

A duty ratio (DR) of the control signal V_{c} can be modulated via pulse width modulation (PWM). The PWM is controlled by software programmed in the driver integrated circuit in which the voltage regulating circuit 20 is installed. Supposing the symbol C stands for the duty ratio of the control signal V_{c}, then the output signal Vₒ of the voltage stabilizing circuit 28 can be calculated according to the following formula:

$${V}_{o} = - \frac{C}{1 - C} * {V}_{d}$$

where V_{d} stands for the input voltage of the voltage stabilizing circuit 28. In detail, V_{d} represents the corresponding sub-voltage V₁, V₂, V₃, V₄, V₅ received by the collector electrode of the transistor 281.

Thus, the output signal Vₒ of the voltage regulating circuit 20 can be stabilized at a desired value by modulating the control signal V_{c} of each voltage stabilizing circuit 28. This means the output signal Vₒ actually output by the voltage stabilizing circuit 28 can be very close to or even the same as a theoretical desired value. Unlike with the above-described conventional voltage regulating circuit 10, the voltage regulating circuit 20 reduces or even eliminates the effects that manufacturing process defects and variations normally have on the actual output signals. That is, the voltage regulating circuit 20 effectively improves the accuracy and reliability of the output signals. When the voltage regulating circuit 20 is applied in an LCD for providing driving voltages, the phenomenon of crosstalk in the LCD can be reduced or even eliminated, and the display quality of the LCD can be improved.

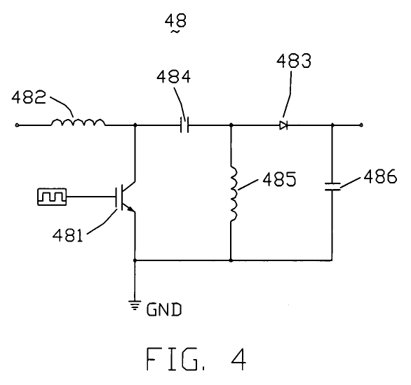

FIG. 3 is a diagram of a voltage stabilizing circuit of a voltage regulating circuit according to a second exemplary embodiment of the present invention. The voltage stabilizing circuit 38 is a Cuk circuit, which includes a transistor 381, a first inductor 382, a diode 383, a capacitor 384, and a second inductor 385. A base electrode of the transistor 381 serves as a control terminal to receive a control signal V_{c}. A collector electrode of the transistor 381 is electrically coupled to an input (not labeled) of the voltage stabilizing circuit 38 via the first inductor 382. An emitter electrode of the transistor 381 is grounded. One terminal of the capacitor 384 is electrically coupled to the collector electrode of the transistor 381. The other terminal of the capacitor 384 is electrically coupled to an output (not labeled) of the voltage stabilizing circuit 38 via the second inductor 385, and is electrically coupled to a positive terminal of the diode 383. A negative terminal of the diode 383 is grounded.

In operation, the input of the voltage stabilizing circuit 38 receives a corresponding sub-voltage V₁, V₂, V₃, V₄, V₅ from the voltage divider (not shown), and simultaneously the base electrode of the transistor 381 receives the control signal V_{c}. When the control signal VC is a high voltage signal, the transistor 381 turns to an on-state. The diode 383 has a reverse bias and turns to an off-state. The first inductor 382 generates an inductive current, transforms the electrical energy to magnetic energy, and then stores the magnetic energy. Simultaneously, the capacitor 384 discharges the stored electrical energy to the output of the voltage stabilizing circuit 38 via the on-state transistor 381. The discharging current causes the second inductor 385 to generate magnetic energy, and this magnetic energy is stored in the second inductor 385.

When the control signal V_{c} is a low voltage signal, the transistor 381 turns to an off-state. The magnetic energy stored in the first inductor 382 is then transformed to electrical energy, which is provided to the capacitor 384 to prevent the voltage of the capacitor 284 from diminishing. Moreover, the second inductor 385 generates an inductive potential, which causes the diode 383 to turn to an on-state. The magnetic energy stored in the second inductor 385 is transformed to electrical energy. Then the electrical energy is provided to the output of the voltage stabilizing circuit 38.

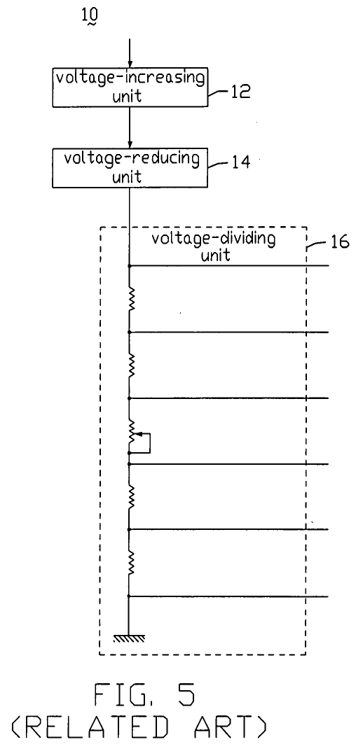

FIG. 4 is a diagram of a voltage stabilizing circuit of a voltage regulating circuit according to a third exemplary embodiment of the present invention. The voltage stabilizing circuit 48 is a Sepic circuit, which includes a transistor 481, a first inductor 482, a diode 483, a first capacitor 484, a second inductor 485, and a second capacitor 486. A base electrode of the transistor 481 serves as a control terminal to receive a control signal V_{c}. A collector electrode of the transistor 481 is electrically coupled to an input (not labeled) of the voltage stabilizing circuit 48 via the first inductor 482. An emitter electrode of the transistor 481 is grounded. One terminal of the capacitor 484 is electrically coupled to the collector electrode of the transistor 481. The other terminal of the capacitor 484 is grounded via the second inductor 485, and is electrically coupled to a positive terminal of the diode 483. A negative terminal of the diode 483 is electrically coupled to an output (not labeled) of the voltage stabilizing circuit 48, and is grounded via the second capacitor 486.

In operation, the input of the voltage stabilizing circuit 48 receives a corresponding sub-voltage V₁, V₂, V₃, V₄, V₅ from the voltage divider (not shown), and simultaneously the base electrode of the transistor 481 receives the control signal V_{c}. When the control signal V_{c} is a high voltage signal, the transistor 481 turns to an on-state. The diode 483 has a reverse bias and turns to an off-state. The first inductor 482 generates an inductive current, transforms the electrical energy to magnetic energy, and then stores the magnetic energy. Simultaneously, the first capacitor 484 discharges the stored electrical energy to the second inductor 485 and the second capacitor 486, respectively. The second inductor 485 generates magnetic energy, and stores the magnetic energy. The voltage of the second capacitor 486 is then provided as the output signal Vₒ of the voltage stabilizing circuit 48.

When the control signal V_{c} is a low voltage signal, the transistor 481 turns to an off-state. The magnetic energy stored in the first inductor 482 is then transformed to electrical energy, which is provided to the capacitor 484 to prevent the voltage of the capacitor 484 from diminishing. Moreover, the second inductor 485 generates an inductive potential, which causes the diode 483 to turn to an on-state. The magnetic energy stored in the second inductor 485 is transformed to electrical energy. The electrical energy is then provided to the second capacitor 486 to prevent the voltage of the second capacitor 486 from diminishing. The voltage of the second capacitor 486 is provided as the output signal Vₒ of the voltage stabilizing circuit 48.

In various alternative embodiments of the voltage regulating circuit 20 and/or the voltage stabilizing circuits 28, 38, 48, each of the voltage stabilizing circuits 28, 38, 48 can be another kind of DC-DC regulating circuit, such as a boost circuit, a buck circuit, or the like. Further, each of the voltage stabilizing circuits 28, 38, 48 can instead be a linear stabilizing circuit including a stabilizing tube or an integrated stabilizer.

It is to be further understood that even though numerous characteristics and advantages of the preferred and exemplary embodiments have been set out in the foregoing description, together with details of the structures and functions of the embodiments, the disclosure is illustrative only; and that changes may be made in detail within the principles of present invention to the full extent indicated by the broad general meaning of the terms in which the appended claims are expressed.

What is claimed is:

1. A voltage regulating circuit, comprising:
a voltage modulating unit for transforming an input voltage to an operation voltage; and
a voltage-dividing unit comprising a voltage divider and at least one voltage stabilizing circuit electrically coupled to the voltage divider;
wherein the voltage divider divides the operation voltage into a plurality of sub-voltages, the at least one voltage stabilizing circuit stabilizes a corresponding one of the sub-voltages at a desired value, and the at least one voltage stabilizing circuit outputs the stabilized voltage.

2. The voltage regulating circuit as claimed in claim 1, wherein the voltage divider comprises a plurality of resistors electrically coupled in series and grounded at one end.

3. The voltage regulating circuit as claimed in claim 2, wherein a resistance of each of the resistors is selected from the group consisting of a fixed resistance and a variable resistance.

4. The voltage regulating circuit as claimed in claim 2, wherein the at least one voltage stabilizing circuit is at least two voltage stabilizing circuits, and each of the voltage stabilizing circuits is electrically coupled to a node selected from the group consisting of a node between two corresponding adjacent of the resistors and a node between one of the resistors and ground.

5. The voltage regulating circuit as claimed in claim 1, wherein the voltage modulating unit comprises a voltage-increasing unit and a voltage-reducing unit electrically coupled with each other.

6. The voltage regulating circuit as claimed in claim 1, wherein the at least one voltage stabilizing circuit is at least one DC-DC regulating circuit.

7. The voltage regulating circuit as claimed in claim 6, wherein the at least one voltage stabilizing circuit comprises a transistor, an inductor, a capacitor, and a diode, wherein a base electrode of the transistor receives a control signal, a collector electrode of the transistor is electrically coupled to an input of the at least one voltage stabilizing circuit, an emitter electrode of the transistor is electrically coupled to a negative terminal of the diode, a positive terminal of the diode is electrically coupled to an output of the at least one voltage stabilizing circuit, and the negative terminal and the positive terminal of the diode are grounded via the inductor and the capacitor, respectively.

8. The voltage regulating circuit as claimed in claim 7, wherein the transistor is an insulated gate bipolar transistor.

9. The voltage regulating circuit as claimed in claim 6, wherein the at least one voltage stabilizing circuit comprises a transistor, a first inductor, a second inductor, a capacitor, and a diode, a base electrode of the transistor receives a control signal, an emitter electrode of the transistor is grounded, a collector electrode of the transistor is electrically coupled to an input of the at least one voltage stabilizing circuit via the first inductor, and is electrically coupled to a positive terminal of the diode via the capacitor, the positive terminal of the diode is electrically coupled to an output of the at least one voltage stabilizing circuit via the second inductor, and a negative terminal of the diode is grounded.

10. The voltage regulating circuit as claimed in claim 6, wherein the at least one voltage stabilizing circuit comprises a transistor, a first inductor, a second inductor, a first capacitor, a second capacitor, and a diode, a base electrode of the transistor receives a control signal, an emitter electrode of the transistor is grounded, a collector electrode of the transistor is electrically coupled to an input of the at least one voltage stabilizing circuit via the first inductor, and is electrically coupled to a positive terminal of the diode via the first capacitor, the positive terminal of the diode is grounded via the second inductor, and a negative terminal of the diode is electrically coupled to an output of the at least one voltage stabilizing circuit, and is grounded via the second capacitor.

11. A voltage regulating circuit, comprising:
a voltage modulating unit for transforming an input voltage to an operation voltage; and
a voltage-dividing unit comprising a voltage divider and a plurality of voltage stabilizing circuits electrically coupled to the voltage divider;
wherein the voltage divider divides the operation voltage into a plurality of sub-voltages, and each of the voltage stabilizing circuits stabilizes a respective one of the sub-voltages at a desired value and outputs the stabilized sub-voltage to a load.

12. The voltage regulating circuit as claimed in claim 11, wherein the voltage divider comprises a plurality of resistors electrically coupled in series.

13. The voltage regulating circuit as claimed in claim 12, wherein a resistance of each of the resistors is selected from the group consisting of a fixed resistance and a variable resistance.

14. The voltage regulating circuit as claimed in claim 12, wherein each of the voltage stabilizing circuits is electrically coupled to a node selected from the group consisting of a node between two corresponding adjacent of the resistors and a node between one of the resistors and ground.

15. The voltage regulating circuit as claimed in claim 11, wherein the voltage regulating circuit is selected from the group consisting of a boost-bust circuit, a Cuk circuit, a Sepic circuit, a boost circuit, a buck circuit, and a linear stabilizing circuit.
